(19) United States
(12) Patent Application Publication
(10) Pub. No.: US 2006/0149545 A1
(43) Pub. Date: Jul. 6, 2006

(54) Method and apparatus of speech template selection for speech recognition

(75) Inventors: Liang-sheng Huang, Taipei (TW); Wen-wei Liao, Taoyuan (TW); Jia-lin Shen, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan (TW)

(21) Appl. No.: 11/294,011

(22) Filed: Dec. 5, 2005

(30) Foreign Application Priority Data
Dec. 31, 2004 (TW) 93141877

(51) Int. Cl. G10L 15/00

(52) U.S. Cl. 704/236

(57) ABSTRACT

A speech input apparatus having a speech input from a user and the method therefor are provided. The speech input apparatus includes a speech template unit providing a plurality of speech templates, an I/O interface outputting and switching the plurality of speech templates to the user to be selected in response to the speech, a speech recognition unit recognizing the speech to provide a result; a database unit storing data; and a search unit searching the database unit for specific data in response to the result.

### FIELD OF THE INVENTION

The present invention relates to a speech input apparatus and method, in particular, to a speech input apparatus and method for speech template selection.

### BACKGROUND OF THE INVENTION

With a speedy improvement of the speech recognition technology, the speech recognition system has been broadly applied to the fields of household appliances, communication, multi-media, and information products. However, one of the issues which inventors often encounter while developing the speech recognition system is that users always do not know what to say to the microphone, in particular when those products of the speech recognition system with a high degree of freedom for speech input, the users are rather at sea. The consequence is that the users cannot experience the benefit the speech input brings.

There are three different schemes for speech input adopted in the apparatus equipped with speech recognition, which are commonly categorized as follows:

1. Input with a single speech template: in this case, the input speech is constrained by a single template according to the limitation of the apparatus, which sometimes makes it insufficient for precisely expressing a target object.

2. Input with diverse speech templates: in this case, users have to read the instructions for understanding the applicable templates for the apparatus. Once the users forget the applicable templates, they must review the manual to remind themselves. Besides, if a nature language is adopted to be an input style, the accuracy of speech recognition would be decreased because of the complexity of natural languages, even though the users can leave it behind the constraint of templates, it will make the speech system decrease its accuracy of speech recognition because of complexity of natural languages.

3. Provision of dialogue or some dialogue-like mechanisms: in this case the users are guided by the instructions via the system interface. There is an interaction established between the system and the users so as to precede the whole speech input procedures step by step. However, such procedures are always time consuming and make the users feel tedious, especially when errors frequently occur during operation, the users may lose their patient.

It is apparent that there are inevitable drawbacks existing in the mentioned schemes, which make the users can not experience the advantages brought by those humanly interfaces when operating the apparatus with speech recognition. Contrarily the user would rather uses an input apparatus with a keyboard than use the voice-commanded apparatus. In consequence, the voice-commanded apparatus comes to a ceiling during the process of popularization.

To overcome the mentioned drawbacks of the prior art, a novel method and apparatus of speech template selection for the speech recognition is provided.

### SUMMARY OF THE INVENTION

According to the first aspect of the present invention, a speech input apparatus having a speech input from a user is provided. The speech input apparatus includes a speech template unit providing and switching a plurality of speech templates, an I/O interface communicating the users for the selection of a desired speech template, a speech recognition unit recognizing the speech to provide a result, a database unit storing content database, and a search unit searching the database unit for specific data in response to the result.

Preferably, the I/O interface is a monitor.

Preferably, the I/O interface is a loudspeaker.

Preferably, the I/O interface contains browsing buttons.

Preferably, the speech recognition unit further includes an input device inputting the speech, an extracting device extracting feature coefficients from the speech, a set of constraint models each of which includes a lexicon model and a language model for providing a first recognition reference, an acoustic model providing a second recognition reference, and a speech recognition engine recognizing the speech according to the feature coefficients, the first recognition reference and the second recognition reference.

Preferably, when a specific speech template is selected by the user, the corresponding lexicon model and language model in response to the specific speech template are activated by the template unit for the speech recognition engine.

According to a second aspect of the present invention, a speech input method is provided. The method includes steps of (a) providing a plurality of speech templates, (b) switching the plurality of speech templates, (c) selecting one of the plurality of speech templates as a selected speech template, (d) activating the lexicon model and language model corresponding to the selected speech template, (e) inputting speech, (f) recognizing the speech according to the constraint model as well as the acoustic model, and generating a result, (g) providing the result to a search unit, and (h) searching for a specific data in a database unit in response to the result.

Preferably, the step (f) includes steps of (f1) extracting feature coefficients from the speech, and (f2) recognizing the speech according to the feature coefficients, the constraint model, and the acoustic model.

Preferably, the step (f1) includes steps of (f11) pre-processing the speech, and (f12) extracting feature coefficients from the speech.

Preferably, the speech consists of signals and the step (f11) further including steps of amplifying, normalizing, pre-emphasizing, and Hamming-Window filtering to the speech.

Preferably, the step (f12) further includes steps of performing a Fast Fourier Transform to the speech and calculating the Mel-Frequency Cepstrum Coefficients for the speech.

According to a third aspect of the present invention, a method for dynamically updating the lexicon model and language model for a speech input apparatus is provided. The speech input apparatus includes a database unit and a constraint-generation unit. The provided method can be applied when the content in database unit is changed: (a) related information in database unit is loaded into the constraint-generation unit, (b) the constraint-generation unit converts the information into the necessary lexicon model and language model for speech recognition, (c) the constraint-generation unit also refreshes indices to the content in the database unit, and (d) the generated lexicon model and language model are stored in the constraint unit.

The foregoing and other features and advantages of the present invention will be more clearly understood through the following descriptions with reference to the drawings:

### BRIEF DESCRIPTION OF THE DRAWINGS

FIG. 1 is a diagram illustrating a speech input apparatus according to a preferred embodiment of the present invention;

FIG. 2 is a diagram showing a hardware appearance of the speech input apparatus according to the preferred embodiment of the present invention;

FIG. 3 is a diagram illustratively showing the generation of the lexicon model and the language model; and

FIG. 4 is a flow chart showing the process for updating the lexicon model and language model necessary for speech recognition according to the preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the aspect of illustration and description only; it is not intended to be exhaustive or to be limited to the precise form disclosed.

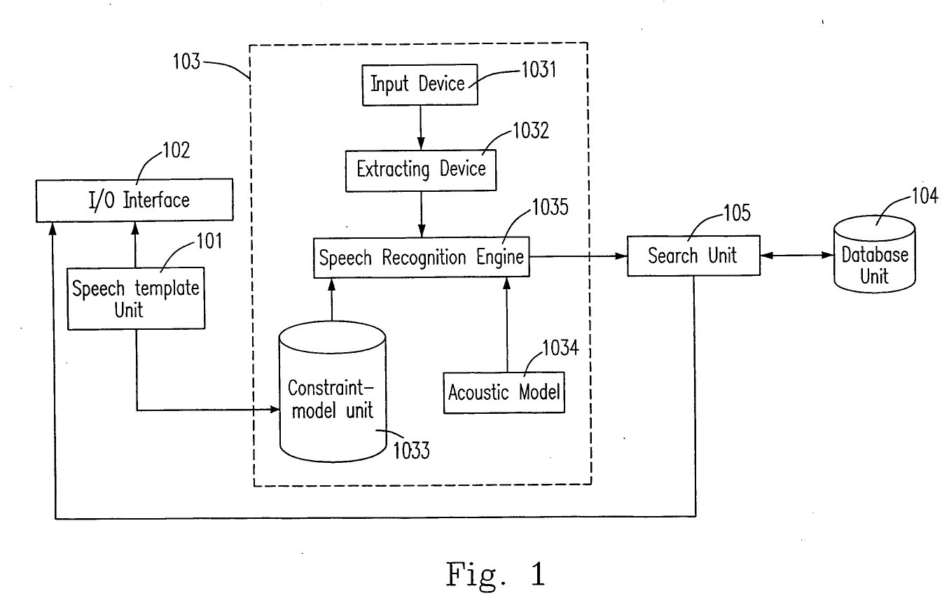

Please refer to FIG. 1, which is a diagram illustrating a preferred embodiment of speech input apparatus. The speech input apparatus includes a speech template unit 101, an I/O interface 102, a speech recognition unit 103, a database unit 104, and a search unit 105. The speech template unit 101 provides a plurality of speech templates that can be switchable and output via the I/O interface 102 so that the users can select one for speech input. The speech recognition unit 103 is used to recognize the respective inputted speech and provide a result correspondingly. Data and information are stored in the database unit 104, and the target is searched therefore via the search unit 105 in response to the result provided by the speech recognition unit 103.

In the aspect of application, the I/O interface 102 includes loudspeaker, display, and browsing buttons preferably. The speech recognition unit 103 further includes an input device 1031, an extracting device 1032, a constraint-model unit 1033 that contains a lexicon model and a language model for each speech template, an acoustic model 1034, and a speech recognition engine 1035. The speech is input via the input device 1031, and the feature coefficients thereof are extracted by the extracting device 1032 therefrom the speech. Then the input speech is recognized by the speech recognition engine 1035. In this case, the recognition is performed according to the extracted feature coefficients, the activated lexicon model and language model in 1033, and the acoustic model 1034, so that a recognition result is produced correspondingly and passed to the search unit 105. Once the user selects a specific template, the corresponding lexicon model and language model will be activated by the speech template unit 101 for the recognition performed by the speech recognition engine 1035.

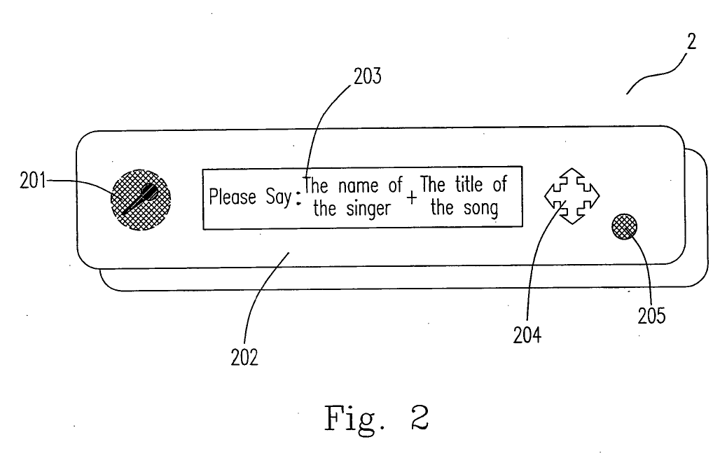

Please refer to FIG. 2 showing a preferred embodiment for hardware appearance of speech input apparatus. The speech input apparatus 2 includes a microphone 201, a monitor 202, a suggested speech template 203, a browsing button 204, and a recording button 205. Users can switch a suggested speech template 203 to be browsed and reviewed through pressing the browsing button 204, and the suggested speech template 203 is displayed on the monitor 202. Take a MP3 flash drive nowadays as an example, if users intend to search a song by speech, the possible speech templates could be “song name”, “singer name”, “singer name+song name” etc. For a handy film player, the possible speech templates could be: “film name”, “protagonist name”, “director name” etc. Via recurring the browsing button 204, those speech templates are sequentially displayed on the monitor 202. After picking up the desired template, the users next press the recording button 205 and then the users can input speech through the microphone 201 following the selected speech template 203.

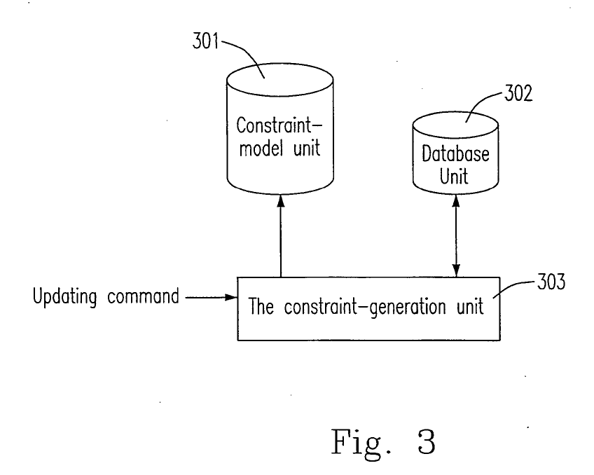

Please refer to FIG. 3 illustrating the way this method updates the lexicon model and language model necessary for speech recognition. Typically the contents such as: songs, film, or any other information existing in a format of archive stored in this sort of apparatus is frequently changed. Once the content is changed, the indices to the content and the lexicon model and language model need to be updated correspondingly for the sake of being searched and recognized. As shown in FIG. 3, when an updating command is ordered, the related information in database unit is loaded into the constraint-generation unit, and subsequently the constraint-generation unit converts the information into the necessary lexicon model and language model for speech recognition. Then the constraint-generation unit also refreshes indices to the content in the database unit, and the generated lexicon model and language model are stored in the constraint unit.

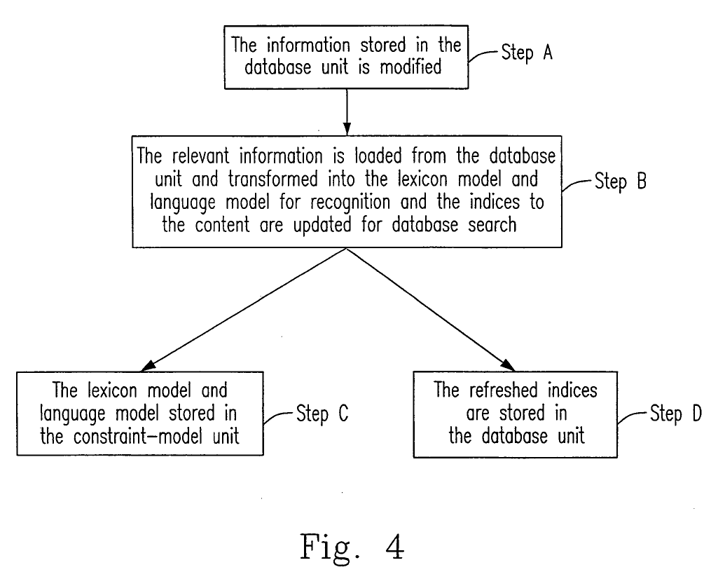

Please refer to FIG. 4 showing the processes this method updates the lexicon model and language model necessary for the speech recognition engine. First of all, in step A, the content stored in the database unit is modified. Next in step B, the relevant information is loaded from the database unit and transformed into the lexicon model and language model for recognition and the indices to the content are updated for database search. In step C, the lexicon model and language model are stored in the constraint-model unit. In step D, the refreshed indices are stored in the database unit.

Preferably, for the aspect of application, the updating command can be added to the selection menu of the speech input apparatus, so that the users can select it therefrom, and the constraint-generation unit is activated accordingly. The above procedures are performed via the constraint-generation unit so as to update the targets. Besides, such procedures can also achieved on PC end rather than on the speech input apparatus itself.

Based on the above, the present invention provides a novel speech apparatus and method. Through the speech input apparatus, the users do not have to keep in mind the input speech templates and the drawback that users do not know what to say to the microphone is overcame. Furthermore, with the cooperation of the voice-commanded device, the users can greatly experience the benefits providing by the speech input apparatus without keeping in mind the commands and speech templates. Besides, the speech input apparatus and method of the present invention have an efficiently increased accuracy and success for the speech recognition because the recognition scope is limited by the selected speech template. Hence, the present invention not only bears a novelty and a progressive nature, but also bears a utility.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims that are to be accorded with the broadest interpretation, so as to encompass all such modifications and similar structures. According, the invention is not limited by the disclosure, but instead its scope is to be determined entirely by reference to the following claims.

1. A speech input apparatus having a speech input from a user, comprising:
a speech template unit providing a plurality of speech templates; an I/O interface communicating the said users for the selection among said plurality of speech templates;
a speech recognition unit recognizing said speech to provide a result; a database unit storing data; and
a search unit searching said database unit for specific data in response to said result.

2. The speech input apparatus according to claim 1, wherein said I/O interface is a monitor.

3. The speech input apparatus according to claim 1, wherein said I/O interface is a loudspeaker.

4. The speech input apparatus according to claim 1, wherein said I/O interface is a browsing button.

5. The speech input apparatus according to claim 1, wherein said speech recognition unit further comprises:
an input device inputting said speech;
an extracting device extracting feature coefficients from said speech;
a constraint-model unit comprising lexicon models and language models for providing a first recognition reference;
an acoustic model providing a second recognition reference; and
a speech recognition engine recognizing said speech according to said feature coefficients, said first recognition reference, and said second recognition reference.

6. The speech input apparatus according to claim 1, wherein when a specific speech template is selected by said user, the specific lexicon model and language model in response to said specific speech template are activated by
said template unit for said speech recognition engine.

7. A speech input method comprising steps of:
(a) providing a plurality of speech templates;
(b) switching said plurality of speech templates;
(c) selecting one of said plurality of speech templates as a selected speech template;
(d) activating one model corresponding to said selected speech template; (e) inputting a speech;
(f) recognizing said speech according to said model, and generating a result;
(g) providing said result to a search unit; and
(h) searching for a specific data in a database unit in response to said result.

8. The speech input method according to claim 7, wherein said step (f) comprises steps of:
(f1) extracting feature coefficients from said speech; and
(f2) recognizing said speech according to said feature coefficients and said model.

9. The method according to claim 8, wherein said step (f1) comprises steps of:
(f11) pre-processing said speech; and
(f12) extracting feature coefficients from said speech.

10. The method according to claim 9, wherein said step (f11) further comprises steps of:
amplifying said speech;
normalizing said speech;
pre-emphasizing said speech;
multiplying said speech by a Hamming Window;
and filtering said speech.

11. The method according to claim 9, wherein said step (f12) further comprises steps of:
performing a Fast Fourier Transform for said speech;
and determining a Mel-Frequency Cepstrum Coefficient for said speech.

12. A method for dynamically updating the constraint-model unit that includes lexicon models and language models for a speech input apparatus, wherein said speech input apparatus comprises a database unit and said constraint-model unit, and said database unit contains some content, comprising steps of:
(a) converting said content into a lexicon model and a language model for recognition;
(b) updating the indices to said content for database search;
(c) storing said lexicon model and said language model to said constraint-model unit; and
(d) storing said indices in said database unit.
